(19) United States
(12) Patent Application Publication
(10) Pub. No.: US 2024/0033803 A1
(43) Pub. Date: Feb. 1, 2024

(54) NOTCHING APPARATUS

(71) Applicant: LG ENERGY SOLUTION, LTD., Seoul (KR)

(72) Inventors: Sung Chul PARK, Daejeon (KR); Sang Wook KIM, Daejeon (KR); Jeong Woo HONG, Daejeon (KR); Dong Hyeuk PARK, Daejeon (KR); Se Hyun YOON, Daejeon (KR); Chun Ho KWON, Daejeon (KR); Chung Hee LEE, Daejeon (KR); Byung Joo JEONG, Daejeon (KR)

(73) Assignee: LG ENERGY SOLUTION, LTD., Seoul (KR)

(21) Appl. No.: 17/768,792

(22) PCT Filed: May 8, 2020
(86) PCT No.: PCT/KR2020/006118

§ 371 Date: Apr. 13, 2022

(30) Foreign Application Priority Data
Dec. 4, 2019 (KR) 10-2019-0160231

(51) Int. Cl. B21D 28/14; H01M 4/04; H01M 10/04

(52) U.S. Cl. CPC B21D 28/14; H01M 4/04; H01M 10/0404

(57) ABSTRACT

A notching apparatus includes a punch that descends to notch an electrode, a holder having one surface in which a mounting groove is provided, the punch having one end inserted into the mounting groove, and a block inserted into the mounting groove together with the punch. When inserted into the mounting groove, the block presses the punch so that the punch comes into close contact with one of inner surfaces of the mounting groove.

### CROSS-REFERENCE TO RELATED APPLICATION

The present application claims the benefit of the priority of Korean Patent Application No. 10-2019-0160231, filed on Dec. 4, 2019, which is hereby incorporated by reference in its entirety.

### TECHNICAL FIELD

The present invention relates to a notching apparatus with which an electrode substrate is cut and processed into an individual electrode in which an electrode tab is formed and, more specifically, to a notching apparatus in which a punch mounted and fixed to a holder is prevented from being shaken.

### BACKGROUND ART

Lithium secondary batteries which are chargeable/dischargeable and lightweight and have high output densities are being widely used as energy sources for various devices.

Also, the lithium secondary batteries have attracted considerable attention as power sources for hybrid electric vehicles (HEV), plug-in hybrid electric vehicles (PHEV), battery electric vehicles (BEV), and electric vehicles (EV), which have been developed to solve limitations, for example, air pollution and green-house gases, caused by existing internal-combustion engine vehicles that use fossil fuels such as gasoline and diesel vehicles.

Such a secondary battery generally has a structure comprising: an electrode assembly in which electrodes (a positive electrode, a negative electrode) and a separator are alternately stacked; an electrolyte for moving ions to the electrodes; and a case in which the electrode assembly and the electrolyte are accommodated.

Also, a method for manufacturing the secondary battery may be mainly divided into: an electrode plate process of manufacturing each of a positive electrode and a negative electrode; an assembly process of manufacturing an electrode assembly using the positive electrode and the negative electrode and inserting the electrode assembly into the case together with an electrolyte; and a formation process of activating ion movement of the electrode assembly. Each of the electrode plate process, the assembly process, and the formation process is divided into individual sub-processes.

Here, the electrode plate process comprises: a mixing process of adding a conductive material and a binder to an active material and mixing the same; a coating process of applying a mixed active material onto a collector; a press process of pressing the active material to a surface of the collector; and a notching and slitting process (a notching process) of cutting an electrode substrate, which is manufactured by adhering the active material to the surface of the collector, into a desired size and then (or simultaneously with the cutting) shearing the cut electrode substrate so as to form an electrode tab.

Here, the electrode substrate in which the active material is applied on the surface of the collector is in a cut state to a certain size, and on the electrode substrate, formed are a coating portion coated with the active material and a non-coating portion not coated with the active material. The active material in the electrode substrate is applied with a smaller width than the collector, and thus the electrode substrate has a structure in which non-coating portions are formed on both side edges with a coating portion therebetween.

A notching apparatus for cutting the electrode substrate to form an electrode tab is generally configured with a punching (press) die that facilitates uniform repeatable processes.

The punching die used in the notching apparatus comprises an upper die and a lower die (or has one of an upper die and a lower die and comprises a supporter instead of the other). One of the upper die and the lower die is fixed, and the other is configured to be vertically slidable to periodically descend and punch an electrode substrate, which is a punch target, while the electrode substrate moves between the upper die and the lower die.

Here, the sliding upper die or lower die has a structure in which a plate-shaped holder 2 is coupled to a plate-shape base 3. A mounting groove 2a is provided in the holder 2, and a punch 1, which strikes the electrode substrate to form a shape or cuts the electrode substrate, is coupled to the mounting groove 2a.

That is, referring to FIG. 1A illustrating a state in which the punch 1 is coupled to the mounting groove 2a of the holder 2, FIG. 1B illustrating a state in which the punch 1 is removed from FIG. 1A, and FIG. 1C illustrating a cross-section of portions of FIG. 1A in which the punch 1 is mounted, the punch 1 is in a state of being inserted into the mounting groove 2a, and the mounting groove 2a is provided to have the same size in a direction in which the punch 1 is inserted.

However, as punching processes are performed continuously, impact and vibration are accumulated, and a gap between the mounting groove 2a and the punch 1 gradually increases (a mounting groove is slightly widened). Thus, shaking of the punch 1 occurs.

An accurate position is not struck due to such shaking of the punch 1, which causes a process failure. Also, a replacement period of the punch 1 and/or the holder 2 is shortened to increase production cost.

### DISCLOSURE OF THE INVENTION

### Technical Problem

Thus, to solve the problems described above, a main objective of the present invention is to provide a notching apparatus in which a gap to be generated in a mounting groove is minimized to prevent a punch from shaking.

### Technical Solution

To achieve the above-described objects, the present invention provides a notching apparatus in which a punch descends to notch an electrode, the notching apparatus comprising: a holder having one surface in which a mounting groove is provided; the punch having one end inserted into the mounting groove; and a block inserted into the mounting groove together with the punch, wherein, when inserted into the mounting groove, the block presses the punch so that the punch comes into close contact with one of inner surfaces of the mounting groove.

The mounting groove comprises a first inner surface perpendicular to a bottom surface of the holder and a second inner surface inclined with respect to the bottom surface of the holder, and the block enters in contact with the second inner surface to press the punch toward the first inner surface.

A portion of the block, which is in contact with the second inner surface, is provided as an inclined surface, and when the portion provided as the inclined surface comes into contact with the second inner surface, an opposite surface of the inclined surface of the block is parallel to an outer circumferential surface of the punch to come into contact with the punch.

In the block, an angle at a point where a virtual line extending from the inclined surface meets a virtual line extending from the opposite surface ranges from 0.5° to 2°.

Friction force between the block and the second inner surface is greater than that between the block and the first inner surface.

The block may be made of a metal material having a friction coefficient greater than that of the punch.

The block is punched to provide a coupling hole, and a female screw thread is provided on an inner circumferential surface of the coupling hole.

Also, friction force between the second inner surface and the block may be greater than that between the block and the punch. That is, a surface between the second inner surface and the block is rougher than that between the block and the punch to increase in friction force. Also, it is desirable the block is made of the same metal material as the holder.

Thus, the present invention may further provide an electrode which is notched by the notching apparatus having the above-described configuration and an electrode assembly which is manufactured by stacking the plurality of electrodes.

### Advantageous Effects

The present invention having the above-described configuration may prevent the punch from shaking because the wedge-shaped block is inserted into the mounting groove together with the punch and presses the punch so that the punch comes into close contact with one of the inner surfaces of the mounting groove.

Since the friction force between the block and the second inner surface is greater than the friction force between the block and the first inner surface, the block may be prevented from separating.

The block is punched to provide the coupling hole, and the female screw thread is provided on the inner circumferential surface of the coupling hole. Thus, the block may be removed using a common tool and a dedicated tool.

### BRIEF DESCRIPTION OF THE DRAWINGS

FIG. 1A is a perspective view illustrating a state in which a punch is coupled to a mounting groove of a holder.

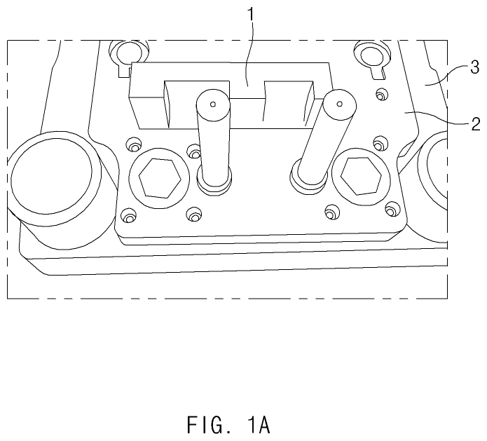

FIG. 1B is a perspective view illustrating a state in which the punch is removed from FIG. 1A.

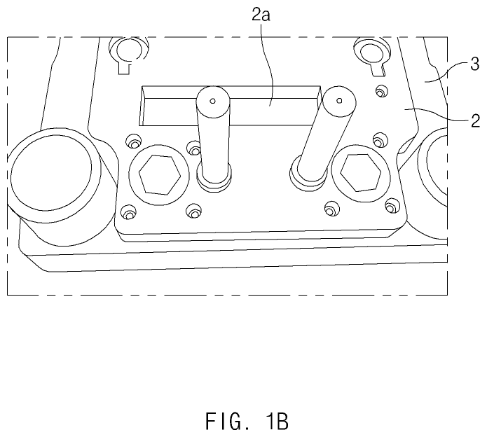

FIG. 1C is a cross-sectional view illustrating a state of portions of FIG. 1A in which the punch is mounted.

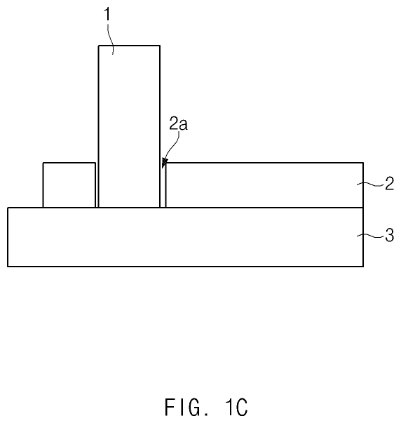

FIG. 2 is a cross-sectional view illustrating a state in which a block according to the present invention is inserted into a mounting groove together with a punch.

FIG. 3 shows an enlarged view illustrating a state in which a second inner surface of a mounting groove and a block are in contact with each other and an enlarged view illustrating a state in which a punch and the block are in contact with each other.

### MODE FOR CARRYING OUT THE INVENTION

Hereinafter, the present invention will be described in detail with reference to the accompanying drawings so that the present invention can be easily carried out by a person skill in the art to which the present invention pertains. However, the present invention may be embodied in several different forms, and not be limited to the embodiments set forth herein.

A part unrelated to the description will be omitted so as to clearly describe the present invention, and the same reference symbols are affixed to identical or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

The present invention is to achieve the above-described object and relates to a notching apparatus in which a punch descends to notch an electrode. Hereinafter, embodiments of the present invention will be described in more detail with reference to the accompanying drawings.

### First Embodiment

A notching apparatus in the embodiment is provided as a punching die that comprises an upper die and a lower die (or at least one of the upper die and the lower die) as described above. That is, one of the upper die and the lower die is fixed, and the other is configured to be vertically slidable to periodically descend and punch an electrode substrate, which is a punch target, while the electrode substrate moves between the upper die and the lower die. In the embodiment, a punch 10 and a holder 20 are mounted on one of the upper die and the lower die, which ascends and descends to perform punching.

Among the upper die and the lower die, the sliding die has a structure in which a plate-shaped holder 20 is coupled to a plate-shaped base 30.

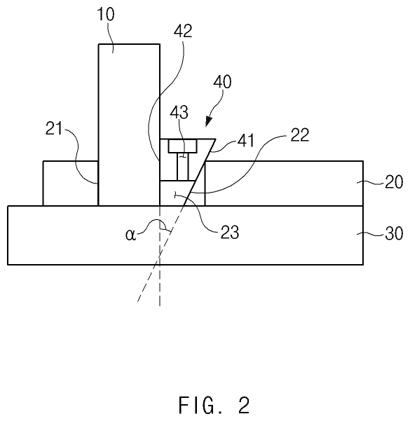

Also, as in FIG. 2 illustrating a state in which a block 40 is inserted into a mounting groove 23 together with the punch 10 according to the present invention, the mounting groove 23 is provided in the holder 20, and the punch 10, which strikes the electrode substrate to form a shape or cuts the electrode substrate, and the block 40 are inserted into the mounting groove 23.

The block 40 has a wedge structure, which is tapered toward one side in a longitudinal direction so as to press the punch 10, so that the punch 10 comes into close contact with one of inner surfaces of the mounting groove 23 when the block 40 is inserted into the mounting groove 23.

That is, in order for the block 40 to be gradually tapered in a direction of entering the mounting groove 23, one surface thereof is formed as an inclined surface 41, and the reverse side (an opposite surface) is formed as a vertical surface 42.

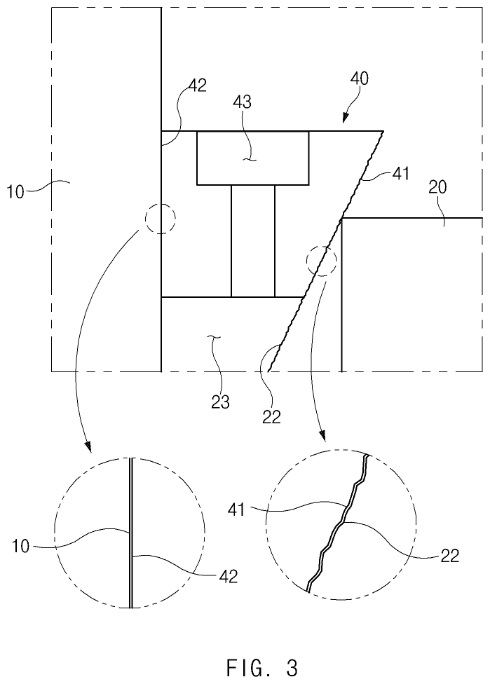

Thus, in the block 40, an included angle α is formed at a point where a virtual line extending from the inclined surface 41 meets a virtual line extending from the opposite surface. In the embodiment, the included angle α ranges from 0.5° to 2°. For reference, although the included angle α is exaggeratedly illustrated in FIGS. 2 and 3 so as to clearly show a state in which the inclined surface 41 is formed, it is desirable that the actual included angle α ranges from 0.5° to 2°, and it is desirable that the included angle α does not exceed 20° as much as possible.

Also, the mounting groove 23 comprises a first inner surface 21 perpendicular to a bottom surface and/or a top surface of the holder 20 and a second inner surface 22 inclined with respect to the bottom surface and/or the top surface of the holder 20.

Thus, when the block 40 enters in a state in which the inclined surface 41 is in contact with the second inner surface 22 of the mounting groove 23, the punch 10 is pressed to be brought into close contact with the first inclined surface 21. That is, when the inclined surface 41 of the block 40 is inserted while sliding on the second inner surface 22, the block 40 presses the punch 10 in the left direction in FIG. 2, and the punch 10 is pressed and brought into contact with the first inner surface 21.

Also, the top surface to be exposed when the block 40 is inserted is punched to a certain depth to provide a coupling hole 43, and a female screw thread is provided on an inner circumferential surface of the coupling hole 43. When the block 40 is pulled out to remove the punch 10, the female screw thread may be engaged with and fixed to a male screw thread of a dedicated tool for removing the block 40.

### Second Embodiment

A notching apparatus in the embodiment provides a structure which has the same structure as the notching apparatus provided in the first embodiment and is capable of efficiently preventing the block 40 from being separating.

That is, referring to FIG. 3 showing an enlarged view illustrating a state in which a second inner surface 22 of a mounting groove 23 and a block 40 are in contact with each other and an enlarged view illustrating a state in which a punch 10 and the block 40 are in contact with each other, an inclined surface 41 of the block 40 and the second inner surface 22 of the mounting groove 23 in the embodiment have relatively more uneven surfaces (have high surface roughness), and friction force may further increase.

Of course, friction force may increase by imparting rough surfaces to areas in which a vertical surface 42 of the block 40 and the punch are in contact with each other. However, since it may be difficult to remove the block 40 so as to replace the punch 10 later if both surfaces of the block 40 have excessively high friction force, it is desirable that surfaces in which the vertical surface 42 of the block 40 and the punch 10 are in contact with each other are relatively smoother (have low surface roughness).

FIG. 3 illustrates that the areas in which the vertical surface 42 of the block 40 and the punch 10 are in contact with each other have the smooth surfaces while the areas between the inclined surface 41 of the block 40 and the second inner surface 22 of the mounting groove 23 have the uneven surfaces. However, the areas between the inclined surface 41 of the block 40 and the second inner surface 22 of the mounting groove 23 may have the smooth surfaces, and the areas in which the vertical surface 42 of the block 40 and the punch 10 are in contact with each other may have the uneven surfaces. Also, according to the surface roughness and the material properties of the block 40 and the punch 10, the areas between the inclined surface 41 of the block 40 and the second inner surface 22 of the mounting groove 23 and the surfaces in which the vertical surface 42 of the block 40 and the punch 10 are in contact with each other may have appropriate roughness.

For reference, it is desirable that the block 40 is made of the same metal material as the holder 20 so as to minimize deformation of the block 40 due to external impact and heat as much as possible. However, when manufactured as described above, different roughness are given to the surfaces to increase the friction force, and thus separation may be prevented.

Also, the block 40 may be made of a metal material having a friction coefficient greater than that of the punch 10.

The present invention having the above-described configuration may prevent the punch 10 from shaking because the wedge-shaped block 40 is inserted into the mounting groove 23 together with the punch 10 and presses the punch 10 so that the punch 10 comes into close contact with one of the inner surfaces of the mounting groove 23.

Since the friction force between the block 40 and the second inner surface 22 is greater than the friction force between the block 40 and the first inner surface 21, the block 40 may be prevented from separating.

The block 40 is punched to provide a coupling hole 43, and a female screw thread is provided on an inner circumferential surface of the coupling hole 43. Thus, the block 40 may be removed using a common tool and a dedicated tool.

Also, as the notching apparatus according to the present invention is provided in the electrode plate process, the present invention may further provide an electrode which is notched by the notching apparatus having the above-described configuration and an electrode assembly which is manufactured by stacking the plurality of electrodes.

Although the present invention is described by specific embodiments and drawings, the present invention is not limited thereto, and various changes and modifications may be made by a person skilled in the art to which the present invention pertains within the technical idea of the present invention and equivalent scope of the appended claims.

1. A notching apparatus comprising:
a holder having one surface in which a mounting groove is provided;
a punch having one end inserted into the mounting groove; and
a block inserted into the mounting groove together with the punch,
wherein, when inserted into the mounting groove, the block presses the punch so that the punch moves toward as inner surface of the mounting groove.

2. The notching apparatus of claim 1, wherein the mounting groove comprises a first inner surface perpendicular to a bottom surface of the holder and a second inner surface inclined with respect to the bottom surface of the holder, and
wherein the block enters in contact with the second inner surface to press the punch toward the first inner surface.

3. The notching apparatus of claim 2, wherein, a portion of the block, which is in contact with the second inner surface, is provided as an inclined surface, and
when the inclined surface comes into contact with the second inner surface, an opposite surface of the inclined surface of the block is parallel to an outer surface of the punch to come into contact with the punch.

4. The notching apparatus of claim 3, wherein, in the block, an angle at a point where a virtual line extending from the inclined surface meets a virtual line extending from the opposite surface ranges from 0.5° to 2°.

5. The notching apparatus of claim 2, wherein friction force between the block and the second inner surface is greater than that between the block and the first inner surface.

6. The notching apparatus of claim 1, wherein the block is punched to provide a coupling hole, and
a female screw thread is provided on an inner circumferential surface of the coupling hole.

7. The notching apparatus of claim 1, wherein the block is made of a metal material having a friction coefficient greater than that of the punch.

8. The notching apparatus of claim 2, wherein friction force between the second inner surface and the block is greater than that between the block and the punch.

9. The notching apparatus of claim 8, wherein a surface between the second inner surface and the block is rougher than that between the block and the punch to increase in friction force.

10. The notching apparatus of claim 1, wherein the block is made of a same metal material as the holder.

11. An electrode notched by the notching apparatus of claim 1.

12. An electrode assembly manufactured by stacking the plurality of electrodes of claim 11.
